(19) United States
(12) Patent Application Publication
(10) Pub. No.: US 2018/0144460 A1
(43) Pub. Date: May 24, 2018

(54) INSPECTION SYSTEM AND INSPECTION METHOD

(71) Applicant: INDUSTRIAL TECHNOLOGY RESEARCH INSTITUTE, Hsinchu (TW)

(72) Inventors: Ping-Cheng HSIEH, Miaoli County (TW); Chun-Chieh WANG, Hsinchu City (TW)

(73) Assignee: INDUSTRIAL TECHNOLOGY RESEARCH INSTITUTE, Hsinchu (TW)

(21) Appl. No.: 15/725,680

(22) Filed: Oct. 5, 2017

(30) Foreign Application Priority Data
Nov. 23, 2016 (TW) 105138515

(51) Int. Cl. G06T 7/00; G01B 11/02; G08B 21/18; G06T 7/62; G06T 7/13

(52) U.S. Cl. CPC G06T 7/0008; G01B 11/022; G08B 21/182; H04N 5/2253; G06T 7/13; G06T 2207/20032; G06T 2207/30164; G06T 7/62

(57) ABSTRACT

An inspection system is adaptive to detect cutting tools stored in a storage having slots. The system includes an image acquisition device and an inspection control device. The image acquisition device is disposed coaxially with one of the slot and is movable along the central axis of the slot. The inspection control device is used to control the image acquisition device to obtain an image of an end face of the cutting tool in the slot. The image has a wearing area. When the maximum width value of a projection of the wearing area projecting on a short reference line in the wearing area exceeds a threshold value, an alerting signal for changing cutting tool is delivered. In addition, an inspection method for an inspection system is provided.

### CROSS-REFERENCE TO RELATED APPLICATIONS

This non-provisional application claims priority under 35 U.S.C. § 119(a) on Patent Application No(s). 105138515 filed in Taiwan on Nov. 23, 2016, the entire contents of which are hereby incorporated by reference.

### TECHNICAL FIELD

The disclosure relates in general to an inspection system and an inspection method, and more particularly an inspection system for detecting cutting tools stored in a storage and an inspection method for the inspection system.

### BACKGROUND

Cutting tools are important in the metal machining industry. During machining, extreme interactions between the cutting tool and a workpiece may cause wear (e.g. flank wear or crater wear) to the cutting tool. In order to achieve high machining quality, it is necessary to pre-check the cutting tool before machining begins. For example, checking the condition of the cutting edge, checking the width/length of the flank and crater wear, and checking if the cutting tool is held in a desired position. To ensure the manufacturing yield and product quality and to fully utilize the cutting tool lifespan, timely changing of the cutting tool, according to the wear inspection, is a promising solution.

### SUMMARY

The disclosure provides an inspection system for detecting cutting tools stored in a storage, and also provides an inspection method for the inspection system.

One embodiment of the disclosure provides an inspection system. The inspection system is adaptive to a storage, and the storage has a plurality of slots for disposing one or more cutting tools. The inspection system includes an image acquisition device and an inspection control device. The image acquisition device is disposed coaxially with one of the slots and movable along a central axis of the slot. The inspection control device is used to control the image acquisition device in order to obtain an image of an end face of a cutting tool disposed in the slot which is disposed coaxially with the image acquisition device. The image of the end face has a wearing area. The wearing area has a long reference line and a short reference line orthogonal to each other. When the maximum width of a projection of the wearing area projecting on the short reference line exceeds a threshold value, an alerting signal for changing cutting tool is delivered.

One embodiment of the disclosure provides an inspection method for an inspection system. The inspection method includes the steps of: obtaining an image of an end face of a cutting tool stored in a storage by an image acquisition device; defining a wearing area of the image of the end face and obtaining the maximum width of the wearing area by analyzing the image of the end face; and determining whether a value of the maximum width exceeds a threshold value. If the threshold value is determined to have been exceeded, delivering an alerting signal for changing cutting tool.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an inspection system and a storage in accordance with a first embodiment of the disclosure.

FIG. 2A is a flow diagram of an inspection method for the inspection system in FIG. 1.

FIG. 2B is a flow diagram of the steps of analyzing an image of an end face of a cutting tool of the inspection system in FIG. 1.

FIG. 3 to FIG. 11 are schematic diagrams of the steps of analyzing the image of the end face of the cutting tool in FIG. 2B.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A number of embodiments are disclosed below with accompanying drawings for elaborating the disclosure. However, the embodiments are for exemplary and explanatory descriptions only, not intent to limit the scope of the disclosure.

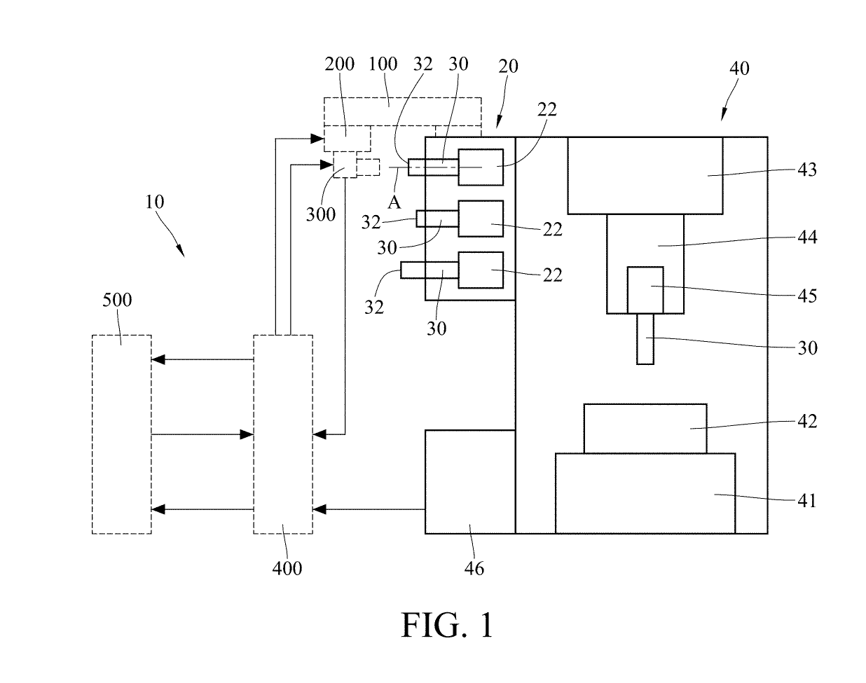

Please see FIG. 1, which is a schematic diagram of an inspection system 10 and a storage 20 in accordance with a first embodiment of the disclosure. The storage 20 includes, for example, three slots 22. The slots 22 are used to dispose cutting tools (also called tool bit) 30. The storage 20 is built in a machine tool 40. The machine tool 40 includes a pedestal 41, a fixture 42, a header 43, a main shaft 44, a tool holder 45 and a controller 46. The fixture 42 is fixed to the pedestal 41. The header 43 is disposed above the fixture 42. The main shaft 44 is fixed to the header 43 and disposed between the fixture 42 and the header 43. The tool holder 45 is fixed to the main shaft 44 and is able to hold one of the cutting tools 30 in position for machining a workpiece (not shown) which is fixed on the fixture 42. The controller 46 is used to replace the cutting tool 30 on the tool holder 45 with another cutting cool 30 in the storage 20, or activate the cutting tool 30 on the tool holder 45 to perform a machining process.

The inspection system 10 includes a support frame 100, a movable platform 200, an image acquisition device 300, an inspection control device 400, and a user interface device 500.

The support frame 100 is fixed to the storage 20. The movable platform 200 is movably disposed on the support frame 100. The image acquisition device 300 is fixed to the movable platform 200 and disposed coaxially with one of the slots 22. As shown in FIG. 1, a central axis of the image acquisition device 300 is coaxial with a central axis A of one of the slots 22. The movable platform 200 is able to move the image acquisition device 300 close to or away from the slot 22.

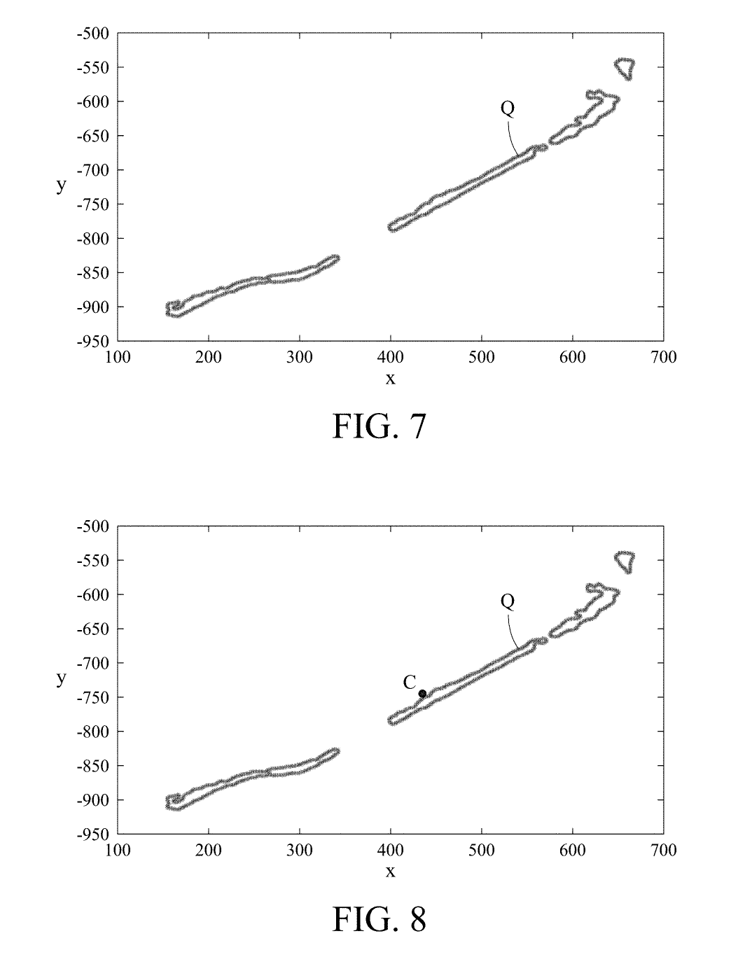

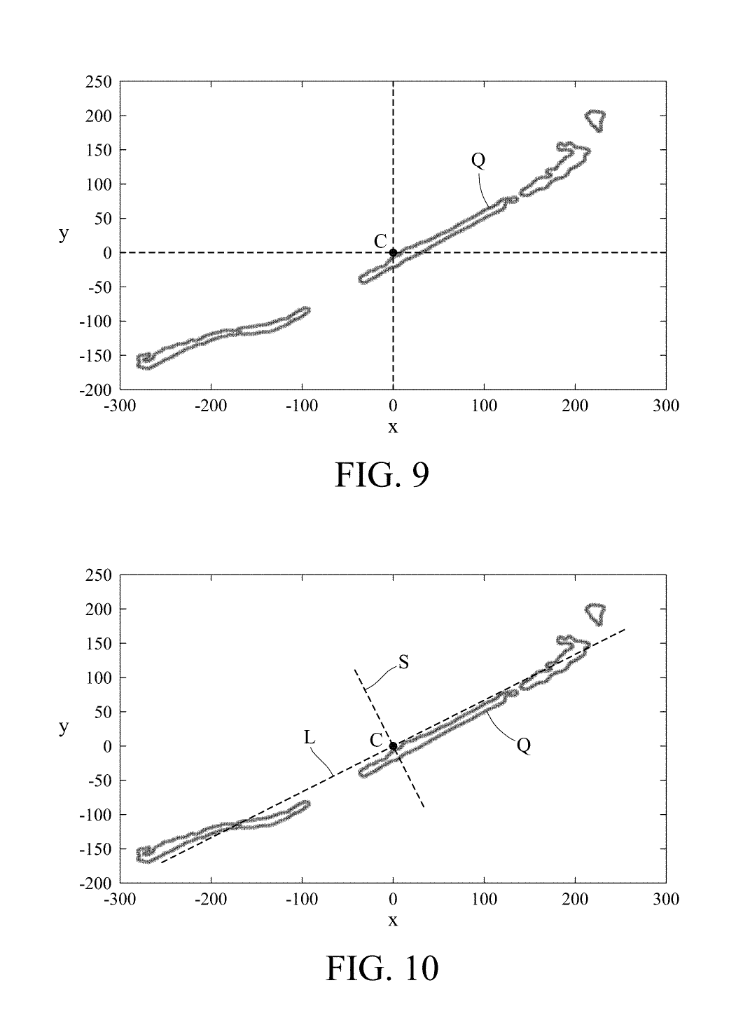

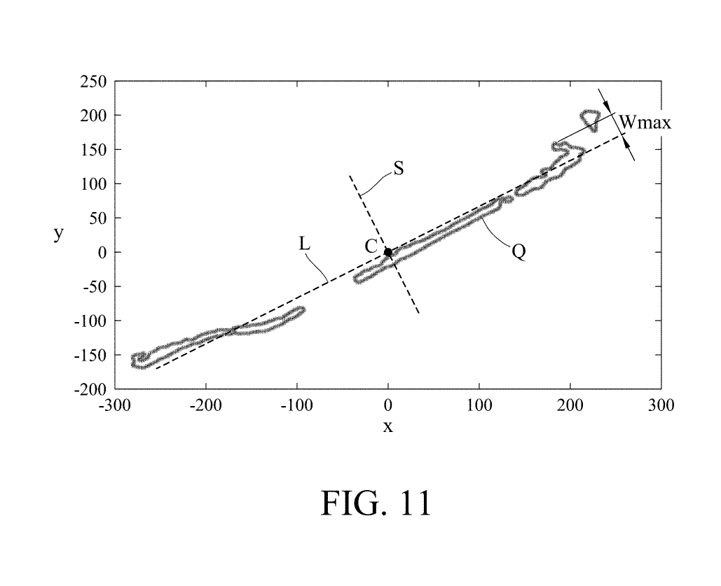

The inspection control device 400 is used to control the image acquisition device 300 in order to obtain an image of an end face 32 of the cutting tool 30 disposed in the slot 22 which is disposed coaxially with the image acquisition device 300. The image of the end face 32 has a wearing area Q, as shown in FIG. 7 to FIG. 10. A long reference line L and a short reference line S, which are orthogonal to each other, are obtained from a contour pixel of the wearing area Q (as shown in FIG. 10). When the maximum width Wmax (as shown in FIG. 11) of a projection of the wearing area Q projecting on the short reference line S exceeds a threshold value, an alerting signal for changing cutting tool is delivered by, for example, the inspection control device 400. The aforementioned threshold value may be an acceptable maximum width which is determined during previous machining processes, or is determined by referring to relevant ISO standards. For example, if the machining quality is slightly lower than expectations during the machining processes, then the current maximum width of the projection of the wearing area projecting on the short reference line will be taken as the acceptable maximum width. For another example, the threshold value for, for example, a Tungsten carbide turning tool may be determined to be 0.3 mm by referring to ISO standard 3685.

The user interface device 500 is, for example, a tablet PC, a notebook, a desktop computer, or a handheld electronic device. The user Interface device 500 can perform an alerting light for changing cutting tool. The alerting light will be performed while delivering the alerting signal. In addition, in this or some other embodiments, the user interface device 500 comprises an input text cell for receiving the threshold value. In another embodiment, the user interface device 500 further comprises an input text cell for receiving tool identification number and an input text cell for receiving length value. The inspection control device 400 is able to adjust the distance between the image acquisition device 300 and the slot 22 according to the length value.

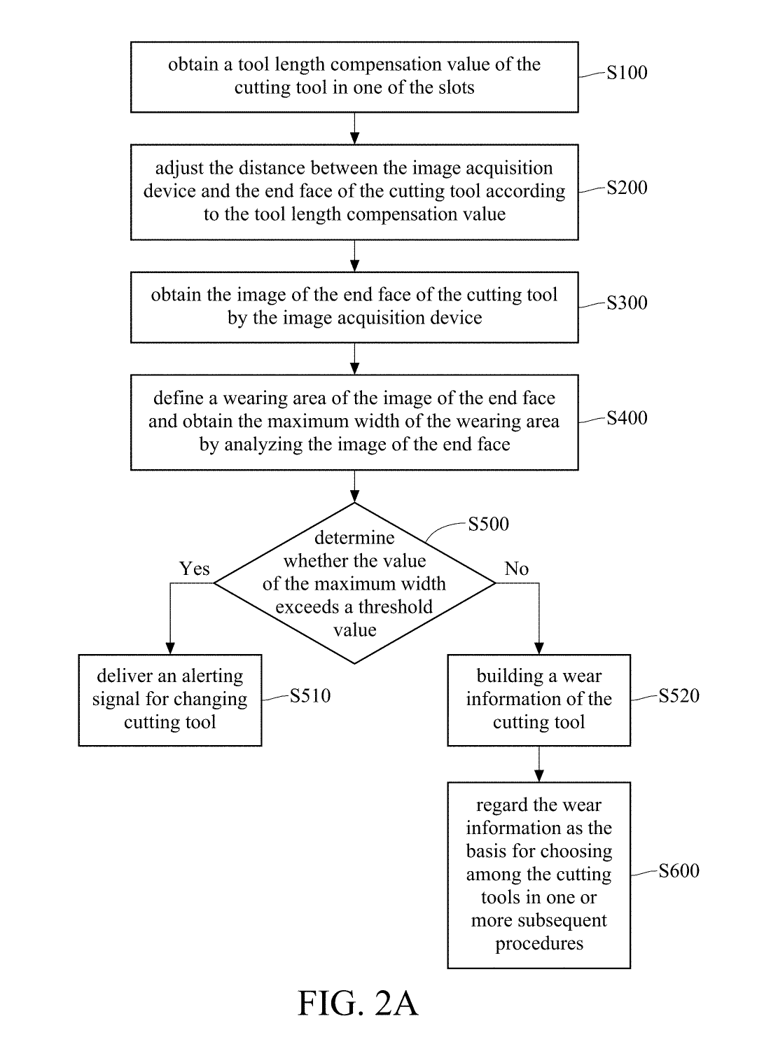

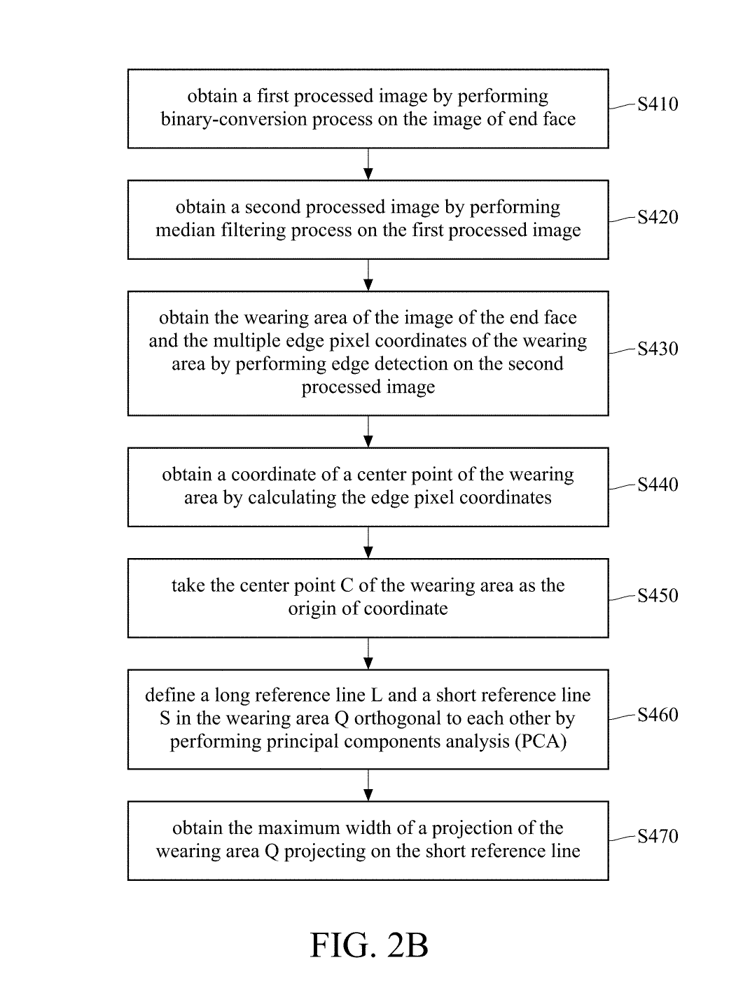

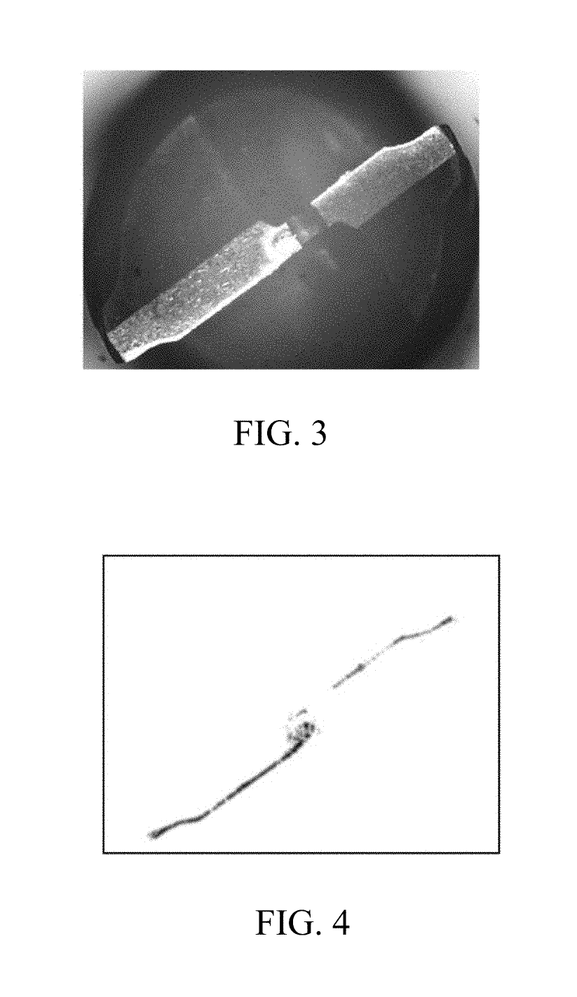

Then, please refer to FIG. 2A to FIG. 11, FIG. 2A is a flow diagram of an inspection method for the inspection system in FIG. 1, FIG. 2B is a flow diagram of the steps of analyzing an image of an end face of a cutting tool of the inspection system in FIG. 1, and FIG. 3 to FIG. 11 are schematic diagrams of the steps of analyzing the image of the end face of the cutting tool in FIG. 2B.

The identification number and the length value of the cutting tool 30 in the storage 20 will be received by the inspection control device 400. Then, how to detect the cutting tool 30 in the inspection system 10 will be described in the following paragraphs.

As shown in FIG. 2A, a tool length compensation value of the cutting tool 30 in one of the slots 22 is obtained in step S100. A distance D1 between the image acquisition device 300 and the cutting tool 30 can be adjusted according to the tool length compensation value. Specifically, because the cutting tools are different in length, the distance between the image acquisition device 300 and the cutting tool 30 should be adjusted according to the respective tool length compensation value in order to get clear image of the end face 32 of the cutting tool 30.

Then, in step S200, the distance D1 between the image acquisition device 300 and the end face 32 of the cutting tool 30 is adjusted according to the tool length compensation value. In detail, the distance D1 can be adjusted to equal to the focal length of the image acquisition device 300 according to the tool length compensation value for ensuring the image quality.

Then, in step S300, the image of the end face 32 of the cutting tool 30 (as shown in FIG. 3) is obtained by the image acquisition device 300.

Then, in step S400, define a wearing area (as shown in FIG. 6) of the image of the end face 32 (as shown in FIG. 3) and obtain the maximum width Wmax (as shown in FIG. 11) of the wearing area by analyzing the image of the end face 32.

Then, in step S500, determine whether the value of the maximum width Wmax exceeds a threshold value. If the threshold value is determined to have been exceeded, then to step S510, delivering an alerting signal for changing the cutting tool 30. If the threshold value is determined to not have been exceeded, then to step S520, building a wear information of the cutting tool 30. The wear information can be, for example, “minor damage”, “moderate damage”, or “acceptable” in accordance with the condition of the wearing area of the end face 32 of the cutting tool 30. However, it is noted that the step S 520 is optional, and the disclosure is not limited thereto. For example, in some other embodiments, the inspection method may be completed without building the wear information of the cutting tool.

In the step S400, the process of analyzing the image of the end face 32 includes steps S410-S470.

In step S410, a first processed image (as shown in FIG. 4) is obtained by performing binary-conversion process on the image of end face 32 (as shown in FIG. 3).

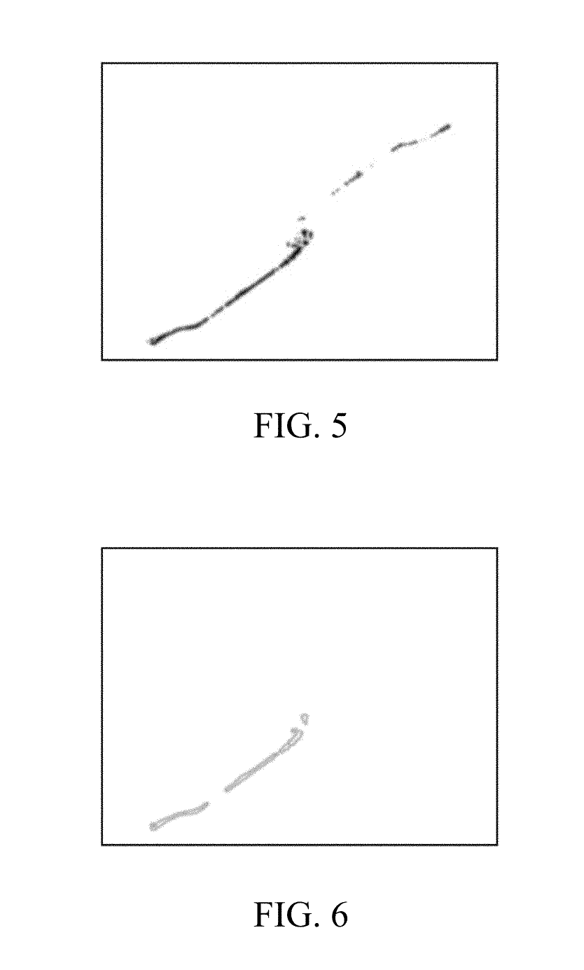

In step S420, a second processed image (as shown in FIG. 5) is obtained by performing median filtering process on the first processed image in FIG. 4.

In step S430, the wearing area (as shown in FIG. 6) of the image of the end face 32 and the multiple edge pixel coordinates (as shown in FIG. 7) of the wearing area are obtained by performing edge detection on the second processed image in FIG. 5.

In step S440, a coordinate of a center point C of the wearing area (as shown in FIG. 8) is obtained by calculating the edge pixel coordinates.

In step S450, the center point C of the wearing area is taken as the origin of coordinate.

In step S460, as shown in FIG. 10, define the long reference line L and the short reference line S in the wearing area Q orthogonal to each other by performing principal components analysis (PCA).

In step 470, as shown in FIG. 11, obtain the maximum width Wmax of a projection of the wearing area Q projecting on the short reference line S.

Usually, the cutting tools in the storage 20 may have different wear conditions. Therefore, different wear information among the cutting tools can be obtained by the aforementioned inspection method. As step S600 shown in FIG. 2A, when the wear information according to multiple cutting tools are built, it is possible to regard this wear information of the cutting tools as the basis for choosing among the cutting tools in one or more subsequent procedures, which is beneficial to improve the manufacturing yield and machining quality, and to fully utilize the cutting tool lifespan.

According to the inspection system and the inspection method as described above, the alerting signal for changing cutting tool can be timely delivered when the maximum width of the projection of the wearing area projecting on the short reference line exceeds the threshold value.

In addition, the inspection method are performed on the cutting tools which are stored in the storage, so the machining process will not be interrupted, which is beneficial to improve machining efficiency.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An inspection system adaptive to a storage, the storage having a plurality of slots for disposing one or more cutting tools, the inspection system comprising:
an image acquisition device disposed coaxially with one of the slots and movable along a central axis of the slot; and
an inspection control device used to control the image acquisition device in order to obtain an image of an end face of a cutting tool disposed in the slot which is disposed coaxially with the image acquisition device, and the image of the end face having a wearing area; and
wherein the wearing area has a long reference line and a short reference line orthogonal to each other, and when the maximum width of a projection of the wearing area projecting on the short reference line exceeds a threshold value, an alerting signal for changing cutting tool is delivered.

2. The inspection system according to claim 1, further comprising a user Interface device for performing an alerting light.

3. The inspection system according to claim 2, wherein the user interface device comprises an input text cell for receiving the threshold value.

4. The inspection system according to claim 2, further including a movable platform and a support frame, the movable platform movably disposed on the support frame, wherein the image acquisition device is fixed to the movable platform so that the image acquisition device is movable with respect to the slots by the platform.

5. The inspection system according to claim 2, wherein the user interface device further including an input text cell for receiving tool identification number and an input text cell for receiving length value, wherein the distance between the image acquisition device and the slot is adjustable by the inspection control device according to the information received by the input text cells.

6. An inspection method for an inspection system, the inspection method comprising:
obtaining an image of an end face of a cutting tool stored in a storage by an image acquisition device;
defining a wearing area of the image of the end face and obtaining the maximum width of the wearing area by analyzing the image of the end face; and
determining whether a value of the maximum width exceeds a threshold value; and if the threshold value is determined to have been exceeded, delivering an alerting signal for changing cutting tool.

7. The inspection method according to claim 6, further comprising, before the step of obtaining the image of the end face of the cutting tool:
obtaining a tool length compensation value of the cutting tool; and
adjusting the distance between the image acquisition device and the cutting tool according to the tool length compensation value.

8. The inspection method according to claim 6, wherein the step of analyzing the image of the end face comprises the steps of:
obtaining a first processed image by performing binary-conversion process on the image of the end face;
obtaining a second processed image by performing median filtering process on the first processed image;
obtaining a wearing area of the end face and multiple edge pixel coordinates of the wearing area by performing edge detection on the second processed image;
obtaining a coordinate of a center point of the wearing area by calculating the edge pixel coordinates;
taking the center point of the wearing area as the origin of coordinates; and
obtaining the maximum width of the wearing area of the end face.

9. The inspection method according to claim 8, further comprising, after the step of taking the center coordinate of the wearing area as the origin of coordinate system:
defining a long reference line and a short reference line in the wearing area orthogonal to each other by performing principal components analysis (PCA); and
obtaining the maximum width of a projection of the wearing area projecting on the short reference line.

10. The inspection method according to claim 6, wherein in the step of determining whether the maximum width exceeds the threshold value, if the threshold value is determined to not have been exceeded, building a wear information of the cutting tool.

11. The inspection method according to claim 10, further comprising, after the step of determining whether the maximum width exceeds the threshold value:
regarding the wear information as the basis for choosing the cutting tool in one or more subsequent procedures.

12. The inspection method according to claim 10, further comprising, after the step of determining whether the maximum width exceeds the threshold value are performed on multiple cutting tools:
obtaining the wear information according to the cutting tools; and
regarding the wear information as the basis for choosing among the cutting tools in one or more subsequent procedures.
